(19) United States
(12) Patent Application Publication
(10) Pub. No.: US 2003/0211197 A1
(43) Pub. Date: Nov. 13, 2003

(54) Method of making formed bodies containing active ingredients

(75) Inventors: Erwin Burkle, Benediktbeuern (DE); Hans Wobbe, Herrsching (DE)

Correspondence Address: Henry M. Feiereisen, Suite 3220, 350 Fifth Avenue, New York, NY, 10118, US

(73) Assignee: KRAUSS-MAFFEI KUNSTSTOFFTECHNIK GMBH, Munchen (DE)

(21) Appl. No.: 10/396,113

(22) Filed: Mar. 25, 2003

(30) Foreign Application Priority Data
Mar. 28, 2002 (DE) 102 13 977.6

(51) Int. Cl. B29C 45/18

(52) U.S. Cl. 425/557; 425/587

(57) ABSTRACT

In a method of making formed bodies with active ingredients, in particular for the pharmaceutical and chemical fields, active ingredients and optional additives are mixed and advanced in a screw and cylinder unit. The resultant material is then injected into a closed mold cavity of a molding tool and injection-molded in the molding tool to finished formed bodies.

### CROSS-REFERENCES TO RELATED APPLICATIONS

This application claims the priority of German Patent Application, Serial No. 102 13 977.6, filed Mar. 28, 2002, pursuant to 35 U.S.C. 119(a)-(d), the disclosure of which is incorporated herein by reference.

### BACKGROUND OF THE INVENTION

The present invention relates to a method of making formed bodies containing active ingredients. Examples of such formed bodies include tablets or pills in the pharmaceutical and cosmetic fields, so-called “carbonation tablets” for making beverages or also pellets in the chemical or detergent industries for producing cleaning solutions.

The manufacture of tablets typically involves the production of a plate or a band of tablet material and subsequently punching out cylindrical tablets therefrom. Residue material, so-called pressed screen, has to be reshaped subsequently, which poses a problem, especially when sensitive active ingredients are involved, or the residue material has to be properly disposed of. Thus, conventional processes involve a two step process, namely the manufacture of a semi-finished product (band, plate) and the formation of the end product.

It would therefore be desirable and advantageous to provide an improved method of making formed bodies containing active ingredients, which obviates prior art shortcomings.

### SUMMARY OF THE INVENTION

According to one aspect of the present invention, a method of making formed bodies with active ingredients, in particular for the pharmaceutical and chemical fields, includes the steps of mixing and advancing active ingredients and optional additives, in a screw and cylinder unit; injecting resultant material into a closed mold cavity of a molding tool; and forming the material in the molding tool.

The present invention resolves prior art problems by employing an injection molding process to make formed bodies which contain active ingredients. The injection molding process is generally known from plastics processing. Hereby, a plastic material is plasticized by a screw and advanced for subsequent injection under pressure into a mold cavity of a mold. These steps may be realized in separate units, i.e. an extruder and an injection unit or in a single aggregate in which the screw combines plasticizing and injection functions.

According to another aspect of the present invention, an injection mold assembly for making formed bodies with active ingredients, includes a screw and cylinder unit having a feed unit for supply of active ingredients and optional additives, with the screw and cylinder unit mixing the active ingredients and optional additives to form a resultant material and advancing the resultant material, and a molding tool having at least one mold cavity, in which the material is injected for subsequent injection molding of a formed body.

According to another feature of the present invention, the screw and cylinder unit is constructed to include an extruder, e.g., a twin-screw extruder, which gently mixes and advances even sensitive materials. Of course, it is also possible to add sensitive active ingredients in controlled doses at a more downstream location into the extruder. The retention time of the active ingredients while under thermal stress and intense shearing stress is hereby significantly decreased. When two injection units are employed, such an extruder is able to operate continuously in a cost-efficient manner to produce formed bodies with constant quality. A high throughput may be implemented, when providing a molding tool with several mold cavities for simultaneously injection-molding a number of formed bodies.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic illustration of one embodiment of an injection molding machine for making formed bodies with active ingredient in accordance with the present invention;

FIG. 2 is a cutaway view of the injection molding machine of FIG. 1; and

FIG. 3 shows a schematic illustration of a single-screw extruder for use in an injection molding machine for making formed bodies with active ingredient in accordance with the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

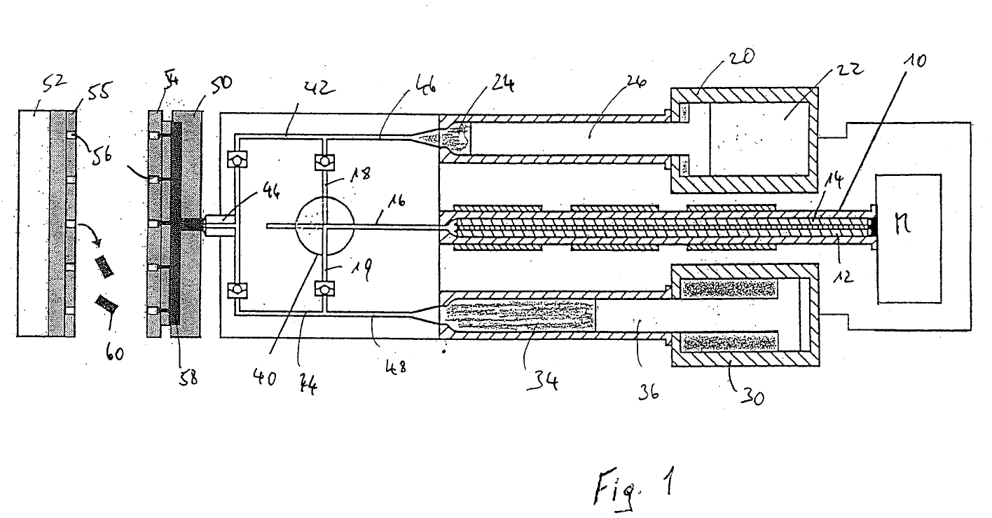

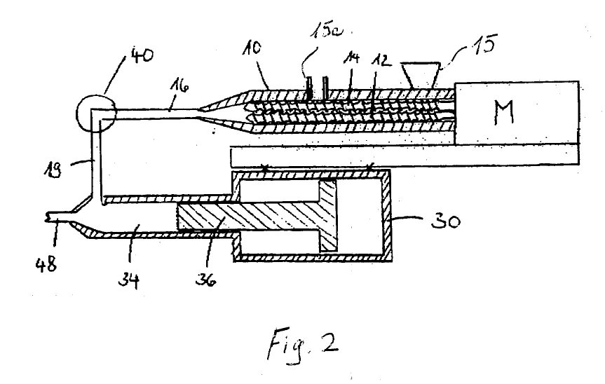

Turning now to the drawing, and in particular to FIG. 1, there is shown a schematic illustration of an injection molding machine for making formed bodies with active ingredient in accordance with the present invention, including a screw and cylinder unit in the form of a twin-screw extruder having a cylinder 10 and two screws 12, 14 accommodated in the cylinder 10 and operated by a motor M. The screws 12, 14 rotate in a same direction. Active ingredients and optional additives, fillers and binding agents are continuously introduced into the cylinder 10 via a feed unit 15 (FIG. 2) and mixed in the extruder, as the screws 12, 14 rotate, and at the same time advanced by the rotation of the screws 12, 14 into the direction of an outlet channel 16. If desired, it is also possible to add more sensitive active ingredients in controlled doses at a more downstream zone into the cylinder 10 of the extruder, as indicated by reference numeral 15a and shown in FIG. 2.

The outlet channel 16 connects to a three-way valve 40 by which the material flow is either routed via a passageway 46 to a first injection unit 20 for accumulation of material in an interior space 24 of the injection cylinder of the injection unit 20, or via a passageway 48 to a second injection unit 30 for accumulation of material in an interior space 34 of the injection cylinder of the injection unit 30. After either one of the injection units 20, 30 is filled, in the operating stage shown in FIG. 1, the injection cylinder of the injection unit 30, a ram 36 is activated to move forward to thereby force the material in the interior space 34 via injection ducts 44 to an injection nozzle 46 and subsequently into the molding tool. Likewise, when the injection cylinder of the injection unit 20 is filled, a ram 26 is activated to move forward to thereby feed the material in the interior space 24 via injection ducts 42 to the injection nozzle 46 for subsequent injection into the molding tool.

The molding tool has a first half-mold 54, mounted on a fixed platen 50, and a second half-mold 55, mounted on a moving platen 50, whereby each of the half-molds 54, 55 is provided with a plurality of mold cavities 56 for formation of formed bodies. During injection, the half-mold 54, 55 are clamped together to close the mold cavities 56, and material is routed from the injection nozzle 46 via a manifold 58, provided in the fixed platen 50, to the mold cavities 56. After conclusion of the injection molding process, the half-molds 54, 55 are moved apart to open for removal or expulsion of finished formed bodies 60 from the molding tool.

The injection units 20, 30 are operated alternately, i.e. while the injection cylinder of one injection unit 20, 30 is filled with material, the other injection unit 20, 30 executes an injection process. As a consequence, a continuous operation of the twin-screw extruder can be realized with high material throughput.

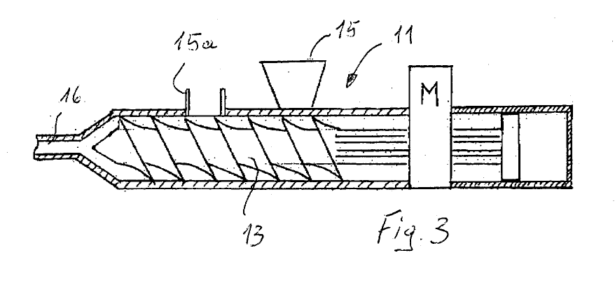

Of course, instead of a twin-screw extruder, as shown in FIG. 1, it is also possible to use a single-screw extruder, shown in more detail in FIG. 3 and generally designated by reference numeral 11. Parts corresponding with those in FIG. 1 are denoted by identical reference numerals and not explained again. The single-screw extruder 11 includes a single screw 13 which not only assumes the functions of mixing and advancing the active ingredient but assumes also the injection function of material into the molding tool.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method of making formed bodies containing active ingredients, in particular for the pharmaceutical and chemical fields, comprising the steps of:
mixing and advancing active ingredients and optional additives in a screw and cylinder unit to produce a resultant material;
injecting the material into a closed mold cavity of a molding tool; and
injection molding the material in the molding tool.

2. The method of claim 1, wherein the material is injected into a plurality of separate mold cavities.

3. The method of claim 1, and further comprising the steps of introducing active ingredients into the screw and cylinder unit at a downstream location of the screw and cylinder unit.

4. An injection mold assembly for making formed bodies containing active ingredients, comprising a screw and cylinder unit having a feed unit for supply of active ingredients and optional additives, said screw and cylinder unit mixing the active ingredients and optional additives to form a resultant material and advancing the resultant material; and a molding tool having at least one mold cavity, said resultant material being injected into the mold cavity for injection-molding a formed body.

5. The injection mold assembly of claim 4, wherein the screw and cylinder unit includes a continuously operating extruder, and further comprising at least one injection unit for injecting the resultant material into the mold cavity, said injection unit operating intermittently.

6. The injection mold assembly of claim 4, wherein the screw and cylinder unit includes a continuously operating extruder, and further comprising two injection units, operating in alternating mode, for injecting resultant material into the mold cavity.

7. The injection mold assembly of claim 5, wherein the extruder is a twin-screw extruder.

8. The injection mold assembly of claim 6, wherein the extruder is a twin-screw extruder.

9. The injection mold assembly of claim 4, wherein the screw and cylinder unit is constructed as a single-screw and injection aggregate.

10. The injection mold assembly of claim 4, wherein the molding tool has a plurality of separate cavities.

11. The injection mold assembly of claim 5, wherein the feed unit for introduction of active ingredients is provided in a downstream area of the extruder.

12. The injection mold assembly of claim 6, wherein the feed unit for introduction of active ingredients is situated in a downstream location of the extruder.
